(19) United States
(12) Patent Application Publication
(10) Pub. No.: US 2014/0135423 A1
(43) Pub. Date: May 15, 2014

(54) Stone-Made Green Energy Paper and Method for Making the Same

(71) Applicant: Real Green Material Technology Corp., Zhunan Township (TW)

(72) Inventor: Hsien Chung Chou, Taipei (TW)

(21) Appl. No.: 13/922,310

(22) Filed: Jun. 20, 2013

(30) Foreign Application Priority Data
Nov. 13, 2012 (TW) 101142305

(51) Int. Cl. D21H 17/68; B29D 7/01

(52) U.S. Cl. CPC D21H 17/68; B29D 7/01
USPC 523/125; 264/175; 264/145

(57) ABSTRACT

The present invention relates to relates to a stone-made green energy paper and a method for making the same, wherein the stone-made green energy paper is made of some non-toxic materials consisting of a stone powder, a pure-white silica powder and a non-toxic resin. This stone-made green energy paper can be used as a base paper for further machining to a green energy writing paper or a green energy art-using paper. The stone-made green energy paper includes the advantages of good ink absorption, high waterproof, high strength, high folding performance, and free-pollution. Moreover, the most important is that the stone-made green energy paper has no CaCo₃ ingredient, so that the stone-made green energy paper can be incinerated through an incinerator, without producing any acid gas.

### BACKGROUND OF THE INVENTION

1. Field of the Invention

The present invention relates to a stone-made paper and related manufacturing method thereof, and more particularly to a stone-made green energy paper and a method for making the same.

2. Description of the Prior Art

Traditionally, 1 metric ton of base papers are made of 4 metric tons of pulpwood, wherein the 4 Mt pulpwood is obtained by felling 23 big trees. Accordingly, it is able to know that the continuous production of the traditional base papers would gradually reduce the forest area on the Earth; and to more seriously, that would further influence ecological balance and cause some environmental issues.

Thus, according to the continuous production of the traditional base papers would influence ecological balance and cause some environmental issues, Taiwan Lung Meng Technology Co., Ltd. proposes an environment protection paper named “stone paper”. Please refer to FIG. 1A and FIG. 1B, there are shown manufacturing procedures of stone papers. As shown in FIGS. 1A and 1B, the stone paper can be made by following steps:
Step (1): As shown in FIG. 1A, choosing a quantity of limestone 1′ and grinding the limestone 1′ to a limestone powder 2′, wherein the limestone 1′ includes at least 70˜80% of CaCo₃.
Step (2): Mixing the limestone powder 2′ with a non-toxic resin 3′ and an additive, wherein the non-toxic resin 3′ can be a polypropylene (PP) or a polyethylene (PE).
Step (3): Fabricating the product of the step (2) to a plurality of paper pellets 4′ by using a pelletizing equipment.
Step (4): As shown in FIG. 1B, making the paper pellets 4′ to a stone paper 5′ by using a rolling equipment.

Comparing to the traditional papers, the stone paper 5′ includes the advantages of:
(1) Adopting a pollution-free manufacturing process: because all the raw materials of the stone paper 5′ are non-toxic materials, the stone-made paper 5′ is made by a pollution-free the manufacturing process, without using any water and pulpwood.
(2) Easy to be recycles: after being exposed by sunlight, the stone paper 5′ would crisp and become to dust, so that the stone-made can easily to be recycled.
(3) Having strong waterproofness: the stone paper 5′ can be further machined to a writing paper with high quality, and this writing paper includes the advantages of: high ink absorption, high strength, easy to be folded, and strong waterproofness.

Although the stone paper 5′ reveals many advantages comparing with the traditional papers, the stone paper 5′ cannot be incinerated by using an incinerator. The reason is that the stone paper 5′ includes CaCo₃ ingredient, so that the stone paper 5′ would produce a lot of acid gas after being incinerated, and the acid gas would erode and damaged the incinerator.

Accordingly, in view of the conventional stone paper still has the drawback of cannot to be incinerated by the incinerator, the inventor of the present has made great efforts to make inventive research thereon and eventually provided a stone-made green energy paper and a method for making the same.

### SUMMARY OF THE INVENTION

The primary objective of the present invention is to provide a stone-made green energy paper, which is made of a stone powder, a pure-white silica powder and a non-toxic resin, and includes the advantages of high ink absorption, high strength, easy to be folded, and strong waterproofness. Moreover, the most important is that the stone-made green energy paper has no CaCo₃ ingredient, so that this stone-made green energy paper can be incinerated through an incinerator, without producing any acid gas.

Accordingly, to achieve the primary objective of the present invention, the inventor of the present invention provides a stone-made green energy paper, comprising: a main material, comprising a stone powder and a pure-white silica powder; and a first sub-material of a non-toxic resin. Wherein the stone powder, the pure-white silica powder and the non-toxic resin are processed to a plurality of paper pellets, and the paper pellets being further made to the stone-made green energy paper by way of a rolling process.

The another objective of the present invention is to provide a method for manufacturing stone-made green energy papers, and the method comprises the steps of: (1) processing and making a plurality of stones to a stone powder; (2) mixing the stone powder and a pure-white silica powder to a main material; (3) fabricating a non-toxic resin to a first sub-material; (4) fabricating the main material and the first sub-material to a plurality of paper pellets by using a pelletizing equipment; and (5) making the paper pellets to a base paper by using a rolling equipment.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIGS. 1A and 1B are manufacturing procedures of stone papers.

FIG. 2 is a flow chart of a method for manufacturing stone-made green energy papers according to the present invention;

FIGS. 3A-3C are schematic processing diagrams of the stone-made green energy papers;

FIG. 4 is a flow chart of a first back-end process for the stone-made green energy paper; and

FIG. 5 is a flow chart of a second back-end process for the stone-made green energy paper.

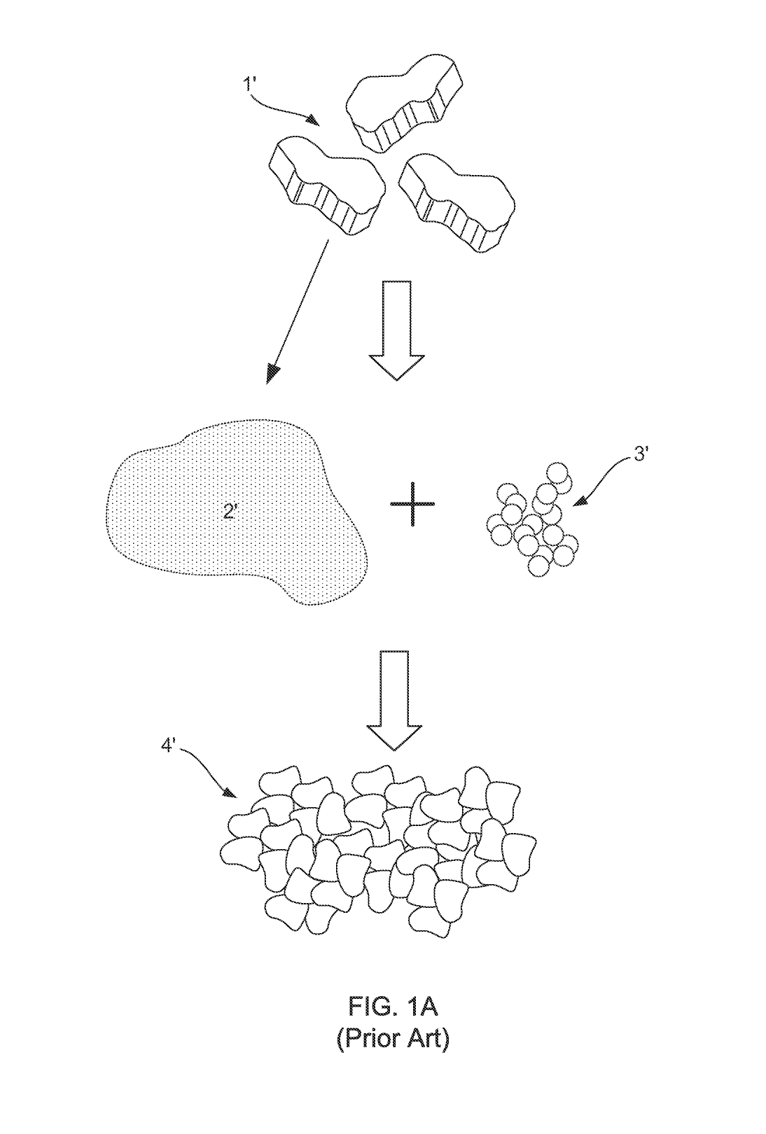

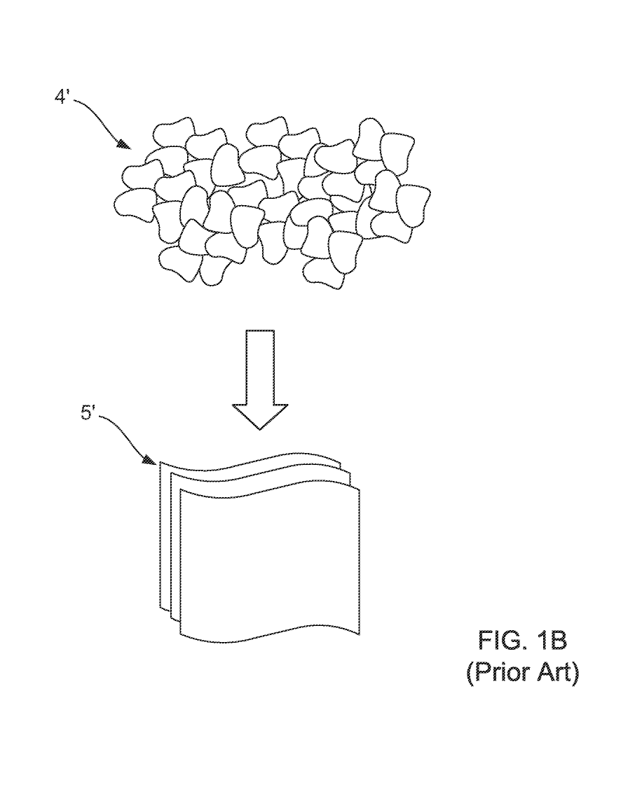

### DETAILED DESCRIPTION OF THE PREFERRED EMBODIMENTS

To more clearly describe a stone-made green energy paper and a method for making the same according to the present invention, embodiments of the present invention will be described in detail with reference to the attached drawings hereinafter.

The stone-made green energy paper of the present invention mainly comprises a main material and a first sub-material, wherein the main material is fabricated by mixing a stone powder and a pure-white silica powder, and the composition of the first sub-material is a non-toxic resin. When manufacturing the stone-made green energy paper, the stone powder, the pure-white silica powder and the non-toxic resin are processed to a plurality of paper pellets, and the paper pellets are further made to the stone-made green energy paper by way of a rolling process.

When manufacturing the stone-made green energy paper, a second sub-material of a glue bond is used for gluing and bonding the stone powder, the pure-white silica powder and the non-toxic resin, so as to increase the glue density between the stone powder, the pure-white silica powder and the non-toxic resin. Moreover, in the present invention, the pure-white silica powder has at least 99% silicon (Si), and the size of the pure-white silica powder is ranged from 10⁻⁶ to 10⁻⁹ m.

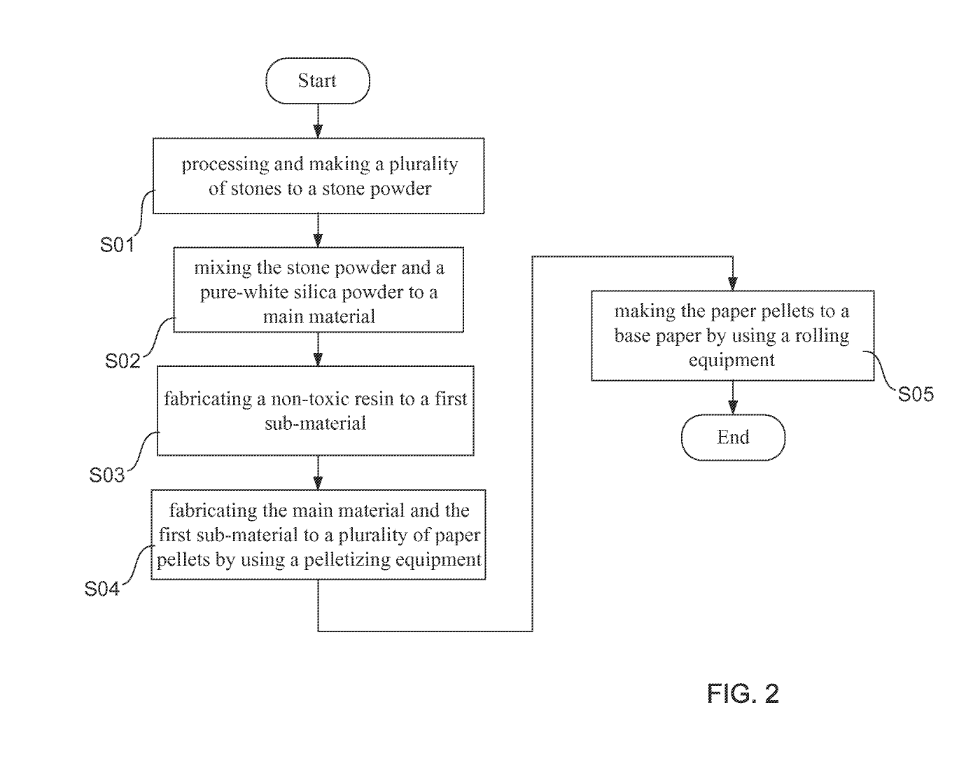

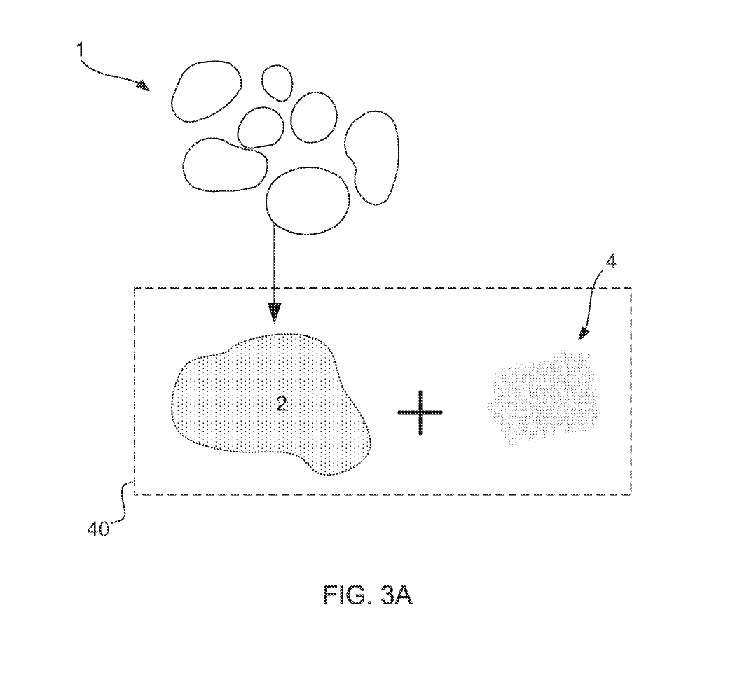

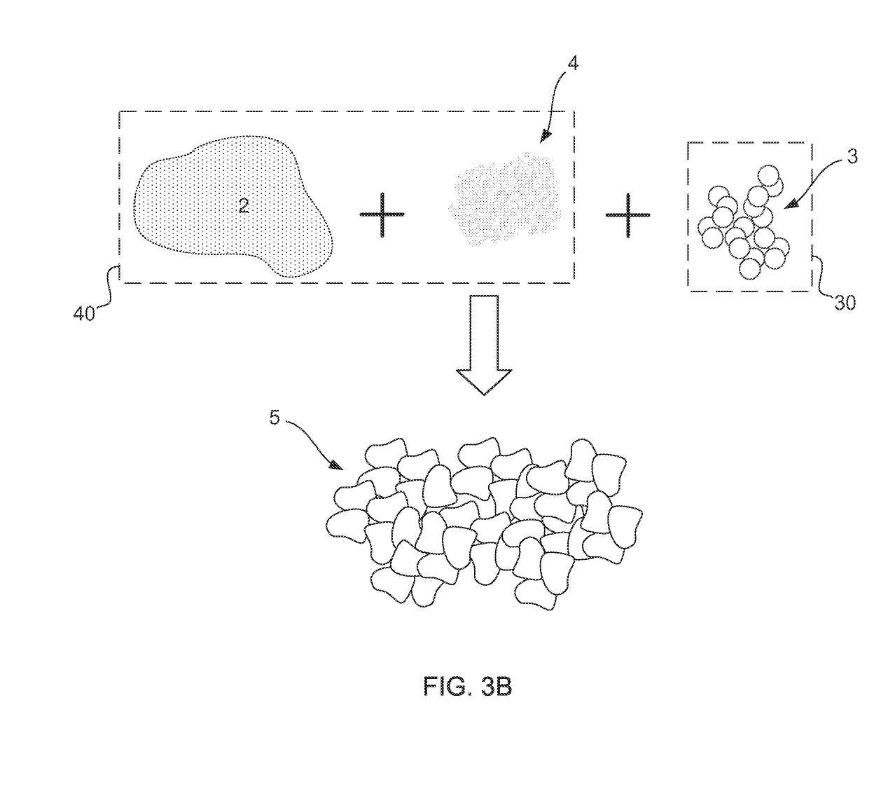

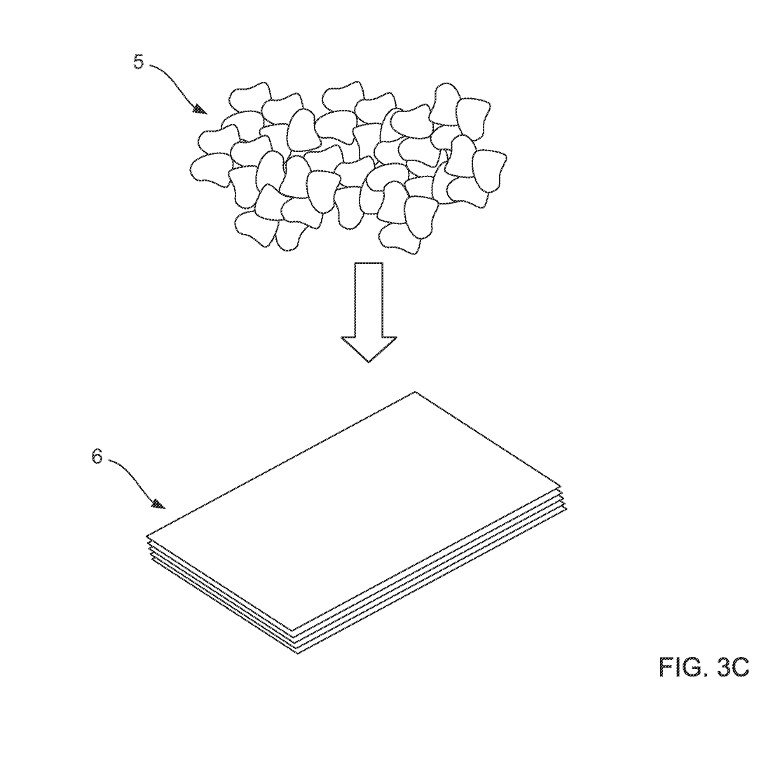

After introducing the constituting elements and the composition of the stone-made green energy paper, a method for manufacturing this stone-made green energy paper will be next introduced in following paragraphs. Please refer to FIG. 2, which illustrates a flow chart of a method for manufacturing stone-made green energy papers according to the present invention; Moreover, please simultaneously refer to FIGS. 3A-3C, there are shown schematic processing diagrams of the stone-made green energy paper. As shown in FIG. 2, the method for manufacturing the stone-made green energy paper consists the steps of:

As shown in FIG. 3A, the method is first proceeded to step (S01) and step (S02), processing a plurality of stones 1 to a stone powder 2 and then mixing the stone powder 2 and a pure-white silica powder 4 to a main material 40. Next, as shown in FIG. 3B, step (S03) and step (SO4) are proceeded for fabricating a non-toxic resin 3 to a first sub-material 30, so as to further fabricate the main material 40 and the first sub-material 30 to a plurality of paper pellets 5 by using a pelletizing equipment. Eventually, as shown in FIG. 3C, step (505) is proceeded for making the paper pellets 5 to a base paper 6 by using a rolling equipment.

In this method for manufacturing the stone-made green energy paper, a second sub-material of a glue bond is used for gluing and bonding the stone powder 2, the pure-white silica powder 4 and the non-toxic resin 3, so as to increase the glue density between the stone powder 2, the pure-white silica powder 4 and the non-toxic resin 3. Moreover, in the method, the pure-white silica powder has at least 99% silicon (Si), and the size of the pure-white silica powder is ranged from 10⁻⁶ to 10⁻⁹ m.

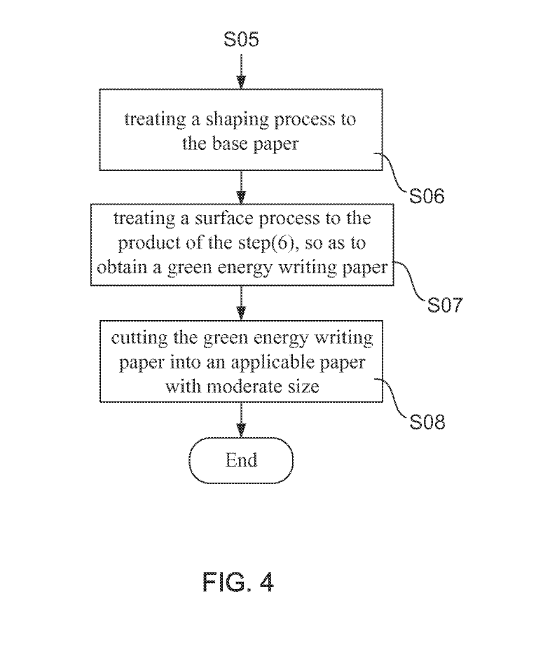

Herein, it needs to further explain that, the stone-made green energy paper manufactured through above-mentioned steps (S01)˜(S05) is still a base paper, which can be further machining to a green energy writing paper or a green energy art-using paper by some back-end processes. Please refer to FIG. 4, which illustrates a flow chart of a first back-end process for the stone-made green energy paper. As shown in FIG. 4, the first back-end process can be executed for machining the stone-made green energy paper to a green energy writing paper, wherein the first back-end process consists the steps of:

First, the first back-end process is proceeded to step (S06) for treating a shaping process to the base paper obtained from above-mentioned step (S05). Next, in the first back-end process, step (S07) is proceeded for treating a surface process to the product of the step (S06), so as to obtain a green energy writing paper. Eventually, the first back-end process is proceeded to step (S08) for cutting the green energy writing paper into an applicable paper with moderate size; for example, cutting to an applicable A4 paper.

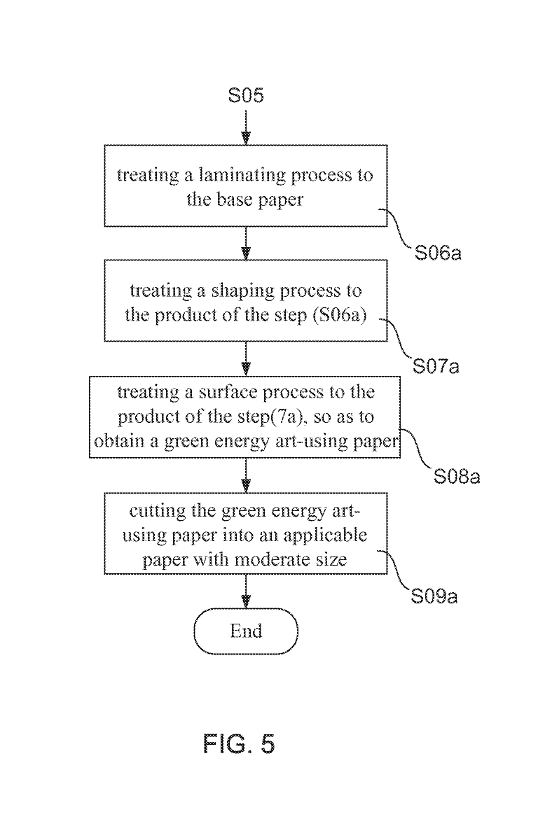

Moreover, please refer to FIG. 5, which illustrates a flow chart of a second back-end process for the stone-made green energy paper. As shown in FIG. 5, the second back-end process can be executed for machining the stone-made green energy paper to a green energy art-using paper, wherein the second back-end process consists the steps of:

First, the first back-end process is proceeded to step (S06a) for treating a laminating process to the base paper obtained from above-mentioned step (S05). Next, in the first back-end process, step (S07a) is proceeded for treating a shaping process to the product of the step (6a). Continuously, step (S078a) is proceeded for treating a surface process to the product of the step(7a), so as to obtain a green energy art-using paper. Eventually, the first back-end process is proceeded to step (S09a) for cutting the green energy art-using paper into an applicable paper with moderate size; for example, cutting to an applicable A4 paper. Therefore, by the second back-end process, the stone-made green energy paper can be further machined to the green energy art-using paper with moderate size, such as clouds paper, dandy paper, writing paper, and colored art paper.

Thus, through the descriptions, the stone-made green energy paper and the method for manufacturing the stone-made green energy paper of the present invention has been completely introduced and disclosed; in summary, the present invention has the following advantages:
1. Adopting a pollution-free manufacturing process: because all the raw materials of the stone-made green energy paper of the present invention are non-toxic materials, the stone-made green energy paper is made by a pollution-free the manufacturing process, without using any water and pulpwood.
2. Easy to be recycles: after being exposed by sunlight, the stone-made green energy paper of the present invention would crisp and become to dust, so that the stone-made green energy paper can easily to be recycled.
3. Having strong waterproofness: the stone-made green energy paper of the present invention can be further machined to a green energy writing paper with high quality, and this green energy writing paper includes the advantages of: high ink absorption, high strength, easy to be folded, and strong waterproofness.
4. The most important is that, the stone-made green energy paper has no CaCo₃ ingredient, so that the stone-made green energy paper can be incinerated through an incinerator, without producing any acid gas.

The above description is made on embodiments of the present invention. However, the embodiments are not intended to limit scope of the present invention, and all equivalent implementations or alterations within the spirit of the present invention still fall within the scope of the present invention.

What is claimed is:

1. A stone-made green energy paper, comprising:
a main material, comprising a stone powder and a pure-white silica powder; and
a first sub-material of a non-toxic resin;
wherein the stone powder, the pure-white silica powder and the non-toxic resin are processed to a plurality of paper pellets, and the paper pellets being further made to the stone-made green energy paper by way of a rolling process.

2. The stone-made green energy paper of claim 1, further comprising a second sub-material of a glue bond, used for gluing and bonding the stone powder, the pure-white silica powder and the non-toxic resin.

3. The stone-made green energy paper of claim 1, wherein the pure-white silica powder has at least 99% silicon (Si).

4. The stone-made green energy paper of claim 1, wherein the size of the pure-white silica powder is ranged from 10⁻⁶ to 10⁻⁹ m.

5. The stone-made green energy paper of claim 1, wherein the non-toxic resin is selected from the group consisting of: polypropylene (PP) and polyethylene (PE).

6. A method for manufacturing stone-made green energy papers, comprising the steps of:
(1) processing and making a plurality of stones to a stone powder;
(2) mixing the stone powder and a pure-white silica powder to a main material;
(3) fabricating a non-toxic resin to a first sub-material;
(4) fabricating the main material and the first sub-material to a plurality of paper pellets by using a pelletizing equipment; and
(5) making the paper pellets to a base paper by using a rolling equipment.

7. The method for manufacturing the stone-made green energy papers of claim 6, further comprising the steps of:
(6) treating a shaping process to the base paper;
(7) treating a surface process to the product of the step (6), so as to obtain a green energy writing paper; and
(8) cutting the green energy writing paper into an applicable paper with moderate size.

8. The method for manufacturing the stone-made green energy papers of claim 6, further comprising the steps of:
(6a) treating a laminating process to the base paper;
(7a) treating a shaping process to the product of the step (6a);
(8a) treating a surface process to the product of the step (7a), so as to obtain a green energy art-using paper; and
(9a) cutting the green energy art-using paper into an applicable paper with moderate size.

9. The method for manufacturing the stone-made green energy papers of claim 6, wherein a second sub-material of a glue bond can further be used in the step (4), so as to glue and bond the stone powder, the pure-white silica powder and the non-toxic resin.

10. The method for manufacturing the stone-made green energy papers of claim 6, wherein the pure-white silica powder has at least 99% silicon (Si).

11. The method for manufacturing the stone-made green energy papers of claim 6, wherein the size of the pure-white silica powder is ranged from 10⁻⁶ to 10⁻⁹ m.

12. The method for manufacturing the stone-made green energy papers of claim 6, wherein the non-toxic resin is selected from the group consisting of: polypropylene (PP) and polyethylene (PE).
